(19) United States
(12) Patent Application Publication
(10) Pub. No.: US 2008/0011976 A1
(43) Pub. Date: Jan. 17, 2008

(54) Steam Inlet Valve of a Steam Turbine

(76) Inventor: Richard Brendon Scarlin, Obweflachs (CH)

Correspondence Address: CERMAK KENEALY & VAIDYA LLP, 515 E. BRADDOCK RD, SUITE B, ALEXANDRIA, VA, 22314, US

(21) Appl. No.: 11/776,665

(22) Filed: Jul. 12, 2007

(30) Foreign Application Priority Data
Jul. 17, 2006 (CH) 01145/06

(51) Int. Cl. F16K 51/00

(52) U.S. Cl. 251/368

(57) ABSTRACT

A steam inlet valve (1) of a steam turbine, with a valve seat (2) and a valve body (3) which, when the valve is closed, bears via a contact region (5) with sealing effect on a contact region (5′) of the valve seat (2). At least one of the two contact regions (5, 5′) has at least one sealing region (6) which faces the other contact region (5, 5′), a base region (7) which faces away from the sealing region (6), and a transition region (8) which is situated between them, wherein the sealing region (6) is formed from a sealing material (B) and the base region (7) is formed from a base material (A), which the valve seat (2) or the valve body (3) also approximately comprises. In order to increase the wear resistance of the contact regions (5, 5′) and of the steam inlet valve (1) as a result of it, the concentration of the base material (A) reduces from the base region (7) in the direction towards the sealing region (6) in the same way as the concentration of the sealing material (B) reduces from the sealing region (6) in the direction towards the base region (7), so that both materials (A, B) are to be found in the transition region (8).

This application claims priority under 35 U.S.C. § 119 to Swiss application number 01145/06, filed on 17 Jul. 2006, the entirety of which is incorporated by reference herein.

### BACKGROUND

1. Field of Endeavor

The invention relates to a steam inlet valve of a steam turbine, with a valve seat and a valve body.

2. Brief Description of the Related Art

Steam inlet valves of steam turbines are customarily highly stressed and, as a result, are subjected to increased wear. In particular, the high temperatures of several hundreds ° C., which occur during operation of the steam turbine, together with the mechanical loads which act upon the steam inlet valves, create creep which negatively affects the function of the steam inlet valve when considered in the longer term. Furthermore, high mechanical loads during a sporadic, temporary closing of the steam inlet valve, various oxidation processes, and erosion which is initiated by solid particles, can occur, which all can bring about an impairment of the function of the steam inlet valve. In order to be able to act against such wear, coatings of so-called stellites, which typically contain chrome, cobalt, tungsten, and carbon and which have a low creep tendency and also a high wear resistance, are known in the region of a valve seat and/or of a valve body which, when the valve is closed, bears via a contact region with sealing effect upon the valve seat. Such coatings are customarily fused onto the component which is to be coated.

Since, however, especially steam turbines of the modern type of construction are operated with constantly rising temperatures, even such coatings border on their load limits. An increase of instabilities in the microstructure can occur especially in the transition region between the coating and the valve seat or the valve body respectively, which can lead in the long term to cracking or detaching of the coating. The constantly rising steam temperatures, as mentioned in the introduction, and the temperature stresses which result from them, and also the repeated cyclic temperature stresses which result from accelerating or running down of the steam turbine, as the case may be, on one hand are responsible for this.

### SUMMARY

One of numerous aspects of the present invention involves an increased service life for a steam inlet valve of a steam turbine of the aforementioned type.

Another aspect of the present invention includes providing, in a steam inlet valve of a steam turbine with a valve seat and a valve body, a region with a wear-resistant coating which is responsible for the sealing function of the steam inlet valve, which coating is powder-metallurgically bonded to the associated valve seat or to the associated valve body, as the case may be, and, as a result, preferably creates an even transition between a base material, which the valve seat and the valve body include, and a sealing material, without an abrupt transition between the base material and the sealing material of the coating taking place, which can especially lead to a weakening at the material interfaces. In an exemplary steam inlet valve, the valve body, when the valve is closed, bears via a contact region with sealing effect on a corresponding contact region of the valve seat. In this case, at least one of the contact regions has at least one sealing region which faces the respective other contact region, a base region which faces away from this, and a transition region which is situated between the respective sealing region and the associated base region. As mentioned above, in this case the sealing region is formed from a sealing material and the base region is formed from a base material, wherein the base material represents in each case the material from which the valve seat or the valve body are also formed. In order to be able to avoid a sharp material interface between the sealing region and the base region, and also to avoid the weakening in this region which is associated with it, the portion of the base material reduces from the base region in the direction of the transition region, while the portion of the sealing material reduces in the opposite direction, that is from the sealing region towards the transition region. This leads to sealing material being preferably exclusively found in the sealing region, base material being preferably exclusively found in the base region, and both materials being found in the transition region between the sealing region and the base region, wherein the respective portion of sealing material or base material in the transition region lies below the respective material maximum which is present in the associated base region or sealing region, as the case may be. By the powder-metallurgical bond between the sealing region and the base region via the transition region which is arranged between them, an almost continuous transition between the base material and the sealing material can be achieved, as a result of which an especially high resistance to cyclic temperature stresses which occur, and an especially good bond between the base region and the sealing region can be achieved.

The sealing region is expediently produced as a separate component and is bonded to the base region of the valve body or of the valve seat via the transition region. This enables a separate production of the sealing region, for example a sealing ring, which is then bonded via a powder-metallurgical process to the base region of the associated valve seat or of the associated valve body, as the case may be, and, as a result, the smooth transition, which is mentioned in the previous paragraph, can also be created between the sealing region and the base region. As a result, sharp material transitions, at which the physical and/or chemical properties are abruptly changed, are especially avoided.

According to a preferred embodiment, the sealing region has a stellite alloy, or is formed by such. Stellites are non-ferrous alloys on a cobalt-chrome basis, and, depending upon the application purpose, contain portions of tungsten, nickel, and carbon which, by forming carbides, has a large influence on the properties of the alloy. Its main feature is a high resistance to abrasion and corrosion, which is maintained even at high temperatures. By means of these properties, they also resist high wear stresses, and, as a result, they qualify for application in steam turbine construction.

In a further advantageous embodiment, at least one transition material, which is different from the base material and from the sealing material, is provided in the transition region, and which reduces from the transition region towards the sealing region and/or towards the base region, while the sealing material reduces from the sealing region towards the transition region, and the base material reduces from the base region, towards the transition region. Such a transition material is especially then of great advantage if the base material and the sealing material can only be bonded to each other with difficulty, even by powder-metallurgical processes. An example for this is a base material which has iron, and a sealing material which has high chrome content (for example, stellite). Since iron and materials with higher chrome content are difficult to be durably bonded to each other, in this case, for example, a material with nickel content can be selected as transition material, which can be durably bonded in the long term both to iron and to a material which has high chrome content. This already shows that not only a direct bond between the base material and the sealing material can be carried out, but also an indirect bond via at least one transition material which is arranged between them, which ensures a long-term and durable bond.

Further important features and advantages of the steam inlet valve according to the invention result from the associated description of the figures with reference to the drawings.

### BRIEF DESCRIPTION OF THE DRAWINGS

Preferred exemplary embodiments of the invention are shown in the drawings and are explained in detail in the following description, wherein like designations refer to like or similar or functionally similar components.

In the drawing in this case, schematically in each case,

FIG. 1 shows a longitudinal section through a steam inlet valve according to the invention, with a valve seat and a valve body,

FIG. 2 shows a diagram to illustrate a concentration of a sealing material and of a base material in a base region, in a transition region, and in a sealing region,

FIG. 3 shows a view as in FIG. 2, however with an additional transition material,

FIG. 4 shows a diagram to illustrate a concentration of a sealing material and of a base material in the different regions with a separately produced sealing region, and

FIG. 5 shows a diagram to illustrate a concentration of a sealing material and of a base material in the different regions, wherein the different regions are produced together.

### DETAILED DESCRIPTION OF EXEMPLARY EMBODIMENTS

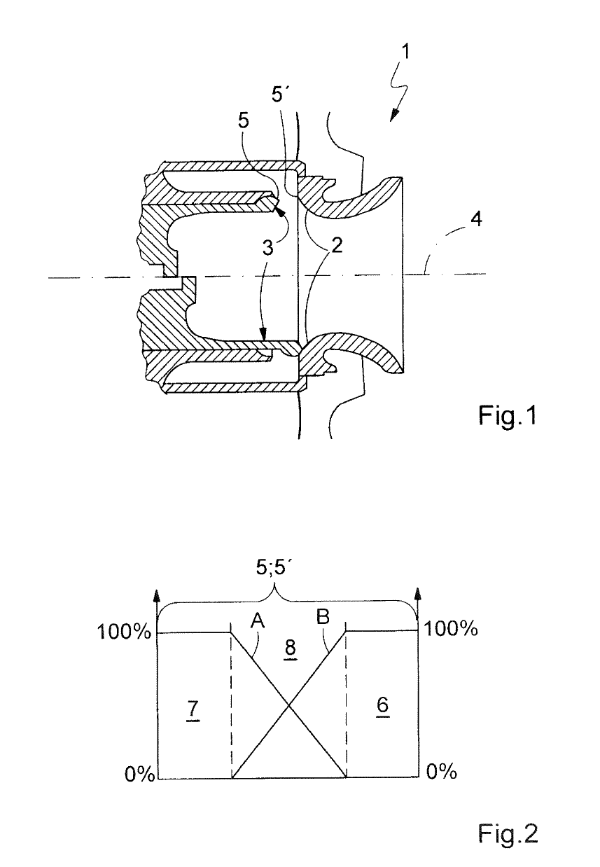

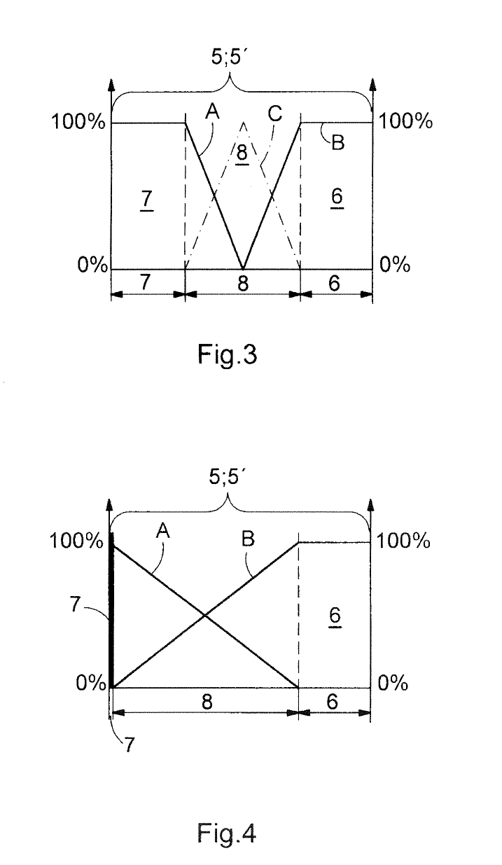

According to FIG. 1, a steam inlet valve 1 according to the invention of a steam turbine, which is not otherwise shown, has a valve seat 2 and an associated valve body 3. In this case, the steam inlet valve 1 is shown in the opened state above a parting line 4, and in the closed state below the parting line 4. When the steam inlet valve 1 is closed, the valve body 3 bears via a contact region 5 with sealing effect on a contact region 5′ of the valve seat 2. In this case, at least one of the two contact regions 5 or 5′ is constructed in multi-layered fashion and has, for example, a construction as shown in FIG. 2 or 3.

A diagrammatic view of the material concentrations A and B which occur in the contact region 5, 5′ is shown in FIG. 2. In this case, the contact region 5, 5′ according to FIG. 2 principally has at least one sealing region 6 which faces the other contact region 5, 5′, a base region 7 which faces away from this sealing region 6, and a transition region 8 which is situated between the sealing region 6 and the base region 7. The base region 7 directly merges into the valve seat 2 or into the valve body 3, as the case may be, or is fastened to the valve seat 2 or to the valve body 3, as the case may be. As is to be gathered from the view in FIG. 2, in this case the sealing region 6 is predominantly formed from a sealing material B, and the base region 7 is largely formed from a base material A. The valve seat 2 and the valve body 3 also include the base material A. In this case, the concentration of the base material A in the base region 7 is preferably approximately 100%, while the concentration of the sealing material B in the sealing region 6 is also approximately 100%.

The concentration of the base material A preferably constantly reduces from the base region 7 in the direction of the sealing region 6, while the concentration of the sealing material B increases from the transition region towards the sealing region 6, the result of which is that in the sealing region 6 there can be at least largely sealing material B, in the base region 7 there can be at least largely base material A, and in the transition region 8 there can be a mixture ratio of the two materials A and B which is dependent upon location. The concentration of the base material A in the transition region 8 is smaller in this case than in the base region 7. It is exactly the reverse with the sealing material B, the concentration of which in the transition region 8 is lower than in the sealing region 6. The view in FIG. 2, for example, describes the situation of a separately produced sealing region 6 being bonded to a separately produced base region 7 by the transition region 8 being powder-metallurgically produced, and, at the same time, a bond between the base region 7 and the sealing region 6 being created.

The transition region 8 can also be powder-metallurgically produced as a separate body, which is then welded to the sealing region 6 and to the base region 7. Also, at least two members of the sealing region 6, transition region 8 and base region 7 group can be commonly powder-metallurgically produced.

In this case, the straight lines which are drawn according to FIGS. 2 to 5, are to be purely exemplarily understood, so that a non-linear progression of the concentrations of the base material A and of the sealing material B, and also other gradients of the two concentration progressions, are also to be covered by the invention. It is especially conceivable that for example the concentration of the base material A does not already drop to zero in the transition region 8 in the same way as the concentration of the sealing material B, but that for example at least a certain portion of the base material A is also still to be found in the sealing region 6.

In the view according to FIG. 3, unlike FIG. 2, a transition material C is additionally provided, which has its maximum concentration in the transition region 8 and reduces from this transition region 8 towards the sealing region 6 and towards the base region 7. Such an additional transition material C, for example nickel, is then especially provided if the two other materials A and B are difficult to be directly bonded to each other or not able to be directly bonded to each other at all, but, however, can be indirectly bonded to each other via the transition material C. This, for example, is the case with a ferrous base material A and a sealing material B with a higher chrome content which are difficult to be directly bonded together, but which are better bondable in each case by the transition material C, for example nickel. This already makes it clear that the transition material C is preferably a different material from the base material A and from the sealing material B.

It is also to be gathered from FIG. 3, that at the place of a concentration maximum of the transition material C, in this case in the middle of the transition region 8, both the base material A and the sealing material B have a concentration minimum. Naturally, it also applies to FIG. 3 that the linear progression of the concentrations of the different materials A, B, C, which is exemplarily shown, is to be purely exemplarily understood, so that material progressions, especially non-linear, which deviate from this, are also to be covered by the invention. Naturally, the concentration of the transition material C in the transition region 8 also must not be 100% at any point, just as little as the concentrations of the base material A and of the sealing material B in the transition region 8 must completely fall to zero.

By means of the transition region 8, in which both the sealing material B and the base material A are present at least in reduced concentration, a transition between the sealing region 6 and the base region 7 can be created, which dispenses with sharp, i.e., especially step-like, material changes. Such sudden material changes are especially responsible for an increased susceptibility to changes of the microstructure and also responsible for formation of cracks as a consequence of temperature changes of the contact regions 5, 5′ which are equipped with it, so that by a smooth and even transition between the individual materials, stresses can be alleviated and, moreover, an improved bond between the individual materials A and B, and alternatively also C, can be achieved. As mentioned, by the transition region 8, the resistance of the contact regions 5, 5′ can be increased, as a result of which the service life of the steam inlet valve 1 can be altogether extended.

In this case, it is conceivable that the sealing region 6 is produced as a separate component and is bonded via the transition region 8 to the base region 7 which is also separately produced, especially by a powder-metallurgical process by which the transition region 8 is produced (cf. FIGS. 2 and 3). As a powder-metallurgical process, sintering or hot isostatic pressing (HIP) are especially a possibility in this case.

A contact region 5, 5′, with a sealing region 6 which is also separately produced, is shown in FIG. 4, which, via a powder-metallurgical process by which the transition region 8 is produced with the base region 7, merges into the base region 7. As is to be gathered from FIG. 4, in the transition region 8 the concentration of the base material A reduces from the base region 7 until it is lowered to approximately 0% at the interface with the sealing region 6. Contrary to this, the concentration of the sealing material B in the transition region 8, increases from the base region 7 until it is approximately 100% at the interface with the sealing region 6.

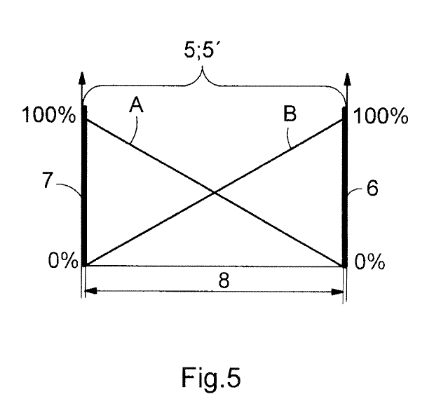

A contact region 5, 5′ is shown in FIG. 5 in which the base region 7 is produced together with the sealing region 6 and the transition region 8. In this case, the concentration of the sealing material B is approximately 100% only in a thin border region of the sealing region 6. In this thin border region, the concentration of the base material A is approximately 0%. A continuous concentration transition of the two materials A and B is shown in the transition region 8.

It is generally conceivable that the sealing region 6 and/or the base region 7, as described in the previous paragraph, are produced together with the transition region 8 by a powder-metallurgical process. In this, the concentration of the base material A, of the sealing material B and optionally the concentration of the transition material C, is dependent upon the respective region 6, 7, 8. Unlike a separate production of the sealing region 6 and the base region 7 with a subsequent bonding, in this embodiment the sealing region 6, the transition region 8 and the base region 7 are produced at the same time.

In addition to a purely powder-metallurgical bond of the individual regions 6, 7, 8, it is also conceivable that the sealing region 6 and/or the base region 7 is bonded, or are bonded, to the transition region 8 in another way, especially welded. A powder-metallurgical bond of the individual regions 6, 7, 8 can be achieved, for example, by sintering or by hot isostatic pressing (HIP), as the case may be. In this case, the following possibilities are principally conceivable:
the transition region 8 and the base region 7 are sintered or hot isostatically pressed (HIP), as the case may be, or
the transition region 8 and the sealing region 6 are sintered or hot isostatically pressed (HIP), as the case may be, or
the transition region 8, the base region 7 and the sealing region 6 are sintered or hot isostatically pressed (HIP), as the case may be, or
the base region 7 and the sealing region 6 are sintered or hot isostatically pressed (HIP), as the case may be.

As base materials A, especially cast steel or forged steel, and also nickel alloys, are a possibility, while as sealing material especially a stellite alloy can be used, which has at least one of the following elements: chrome, tungsten, nickel, carbon, cobalt, molybdenum.

By the powder-metallurgical bonding of the sealing material B, which is particularly advantageous for the sealing function of the steam inlet valve 1, to the base material A of the valve body 3 or of the valve seat 2, or by the powder-metallurgical production of the regions 6, 7, 8, a contact region 5, 5′ with an appreciably increased wear resistance is created, which, moreover, can absorb temperature stresses better on account of the fluid transition. In particular, cracks which stem from severe temperature stresses can be avoided as far as possible on account of the absent sharp material transitions, as a result of which the service life of the steam inlet valve 1 can be increased.

The respective contact region 5, 5′ can be separately produced or manufactured, as the case may be, and then attached to the valve seat 2 or to the valve body 3, as the case may be, for example by a welded bond. It is also fundamentally possible to form the respective contact region 5, 5′ directly on the valve body 3 or on the valve seat 2, as the case may be, during its powder-metallurgical production.

### LIST OF DESIGNATIONS

1 Steam inlet valve
2 Valve seat
3 Valve body
4 Parting line
5 Contact region
6 Sealing region
7 Base region
8 Transition region
A Base material
B Sealing material
C Transition material

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A steam inlet valve of a steam turbine, the inlet valve comprising:
a valve seat having a contact region; and
a valve body having a contact region;
wherein, when the valve is closed, the valve body contact region sealing bears on the valve seat contact region;
wherein at least one of the contact regions has at least one sealing region which faces the other contact region, a base region which faces away from the sealing region, and a transition region situated between the sealing region and the base region;
wherein the sealing region is formed from a sealing material and the base region is formed from a base material, the valve seat or the valve body comprising the base material; and
wherein the concentration of the base material reduces from the base region in the direction towards the sealing region, and the concentration of the sealing material reduces from the sealing region in the direction towards the base region, so that the transition region comprises both the base and sealing materials.

2. The steam inlet valve as claimed in claim 1, wherein the sealing region is produced as a separate component and is bonded to the base region via the transition region.

3. The steam inlet valve as claimed in claim 1, wherein at least one of the sealing region and the base region is produced together with the transition region.

4. The steam inlet valve as claimed in claim 1, wherein at least one of the sealing region and the base region is welded to the transition region.

5. The steam inlet valve as claimed in claim 1, wherein:
the transition region and the base region are sintered or hot isostatically pressed; or
the transition region and the sealing region are sintered or hot isostatically pressed; or
the transition region, the base region, and the sealing region are sintered or hot isostatically pressed; or
the base region and the sealing region are sintered or hot isostatically pressed.

6. The steam inlet valve as claimed in claim 1, wherein the sealing material comprises at least one element selected from the group consisting of chrome, tungsten, nickel, carbon, cobalt, and molybdenum.

7. The steam inlet valve as claimed in claim 1, wherein the sealing region comprises or is formed by a stellite alloy.

8. The steam inlet valve as claimed in claim 1, wherein the base material is cast steel, forged steel, or a nickel alloy.

9. The steam inlet valve as claimed in claim 1, further comprising:
at least one transition material which is different from the base material and from the sealing material, the at least one transition material located in the transition region; and
wherein the concentration of the transition material reduces from the transition region towards the sealing region, towards the base region, or towards both; or
wherein the concentration of the sealing material reduces from the sealing region towards the transition region; or
wherein the concentration of the base material reduces from the base region towards the transition region.

10. The steam inlet valve as claimed in claim 9, where at least one of the base material and the sealing material has a concentration minimum at a point of a concentration maximum of the transition material.

11. The steam inlet valve as claimed in claim 1, wherein at least one of the base material, the sealing material, and the transition material is formed at least partially from metal powder.
